(19) United States
(12) Patent Application Publication
(10) Pub. No.: US 2010/0052447 A1
(43) Pub. Date: Mar. 4, 2010

(54) HYDRODYNAMIC BEARING DEVICE, SPINDLE MOTOR, AND INFORMATION DEVICE

(76) Inventors: Yosuke KADOYA, Ehime (JP); Takafumi Asada, Osaka (JP); Tsutomu Hamada, Osaka (JP); Katsuo Ishikawa, Ehime (JP)

Correspondence Address: WENDEROTH, LIND & PONACK L.L.P., 1030 15th Street, N.W., Suite 400 East, Washington, DC, 20005-1503, US

(21) Appl. No.: 12/548,855

(22) Filed: Aug. 27, 2009

(30) Foreign Application Priority Data
Aug. 27, 2008 (JP) 2008-217699

(51) Int. Cl. H02K 5/167; F16C 32/06

(52) U.S. Cl. 310/90; 384/114

(57) ABSTRACT

The hydrodynamic bearing device has a sleeve composed of a sintered material and having a compression-absorbing space inside the sleeve, the sleeve having a bearing hole in the center thereof; a shaft rotatably inserted into the bearing hole; a bearing portion formed between the bearing hole and the shaft; a hydrodynamic groove formed on at least one of the internal peripheral surface of the bearing hole and the external peripheral surface of the shaft; a concavity having one or more steps and formed to one end of the sleeve in the axial direction; a convexity formed to the other end of the sleeve in the axial direction, the convexity having a shape similar to the concavity; and a lubricating fluid filled in the gap of the bearing portion. The hydrodynamic bearing device has a readily obtainable predetermined shape precision, the internal density of the sintered material is made uniform, and lubricating fluid therein does not leak from the surface.

This application claims priority under 35 U.S.C. §119 to Japanese Patent Application No. 2008-217699 filed on Aug. 27, 2008. The entire disclosure of Japanese Patent Application No. 2008-217699 is hereby incorporated herein by reference.

### BACKGROUND OF THE INVENTION

1. Field of the Invention

The present invention relates to a hydrodynamic bearing device, a spindle motor provided with the hydrodynamic bearing device, and a hard disk drive (hereinafter referred to as “HDD”) or another information device in which the above are mounted.

2. Description of the Related Art

In recent years, there has been an increase in the memory capacity and data transfer rate of rotary disk devices or the like in which a rotating magnetic disk or the like for recording and reproduction is used. Accordingly, there is a need for high performance and reliability in order to constantly rotate a disk with high precision in such rotary devices. In view of this need, a hydrodynamic bearing device suitable for high-speed rotation is generally used as a bearing for such rotary devices.

In response to the above, the hydrodynamic bearing device described in the specification of U.S. Pat. No. 7,186,028 has a sleeve 111 made of a low-cost sintered material, as shown in FIG. 18. A shaft 112 integrally provided with a thrust flange 113 is rotatably inserted into a bearing hole 111C of the sleeve 111. Provided to the lower end of the sleeve are a concavity 111D for placing the thrust flange 113 and a flat surface 111F for fixing a thrust plate 114.

A lubricating fluid 116 is filled in a gap formed by the sleeve 111, the shaft 112, the thrust flange 113, and the thrust plate 114.

Here, a radial hydrodynamic groove 111A is rolled or otherwise formed on the internal peripheral surface of the bearing hole 111C or an external peripheral cylindrical surface of the shaft 112, and configure a radial bearing. A thrust hydrodynamic groove 114A is provided to the thrust plate 114, and the thrust plate 114 faces the thrust flange 113 to form a thrust bearing.

### SUMMARY OF THE INVENTION

However, the sleeve 111 having the configuration of the above-described prior art has a plurality of step portions, and therefore has the following problems. Specifically, in order to produce a sleeve 111 having such a complicated shape using a sintered material, a predetermined shape is obtained by preparing a mold that corresponds to the shape of the sleeve 111, filling a metal powder into the mold, thereafter applying pressure from above and below, and compressing the metal powder so that the gaps between the metal powder is reduced.

However, the sleeve 111 has a complicated shape as noted above and pressure is merely applied in the axial direction. Therefore, the internal density of the product is not necessarily uniform.

In the case of the sleeve 111 shown in FIG. 18, the radial bearing periphery of the internal periphery of the sleeve having a short axial length tends to have high density, and the portion in the vicinity of the external periphery of the sleeve having a great axial length tends to have low density.

FIG. 19 is an enlarged image of the surface of the sintered material of the sleeve 111. As shown in the drawing, numerous (about 2% or more in terms of the surface area ratio) residual surface pores 111r are left on the surface of the sleeve 111 in the low-density portion, pressure from the surface of the sleeve 111 is reduced/diffused, the bearing performance is degraded, and the bearing is liable to rub under high-temperature environments or the like. After operation for a long period of time under a high-temperature environment, lubricating fluid 116 passes through the residual surface pores 111r and is liable to leak to the exterior of the bearing from the surface of the low-density portion.

It is possible to consider increasing the density of the sleeve 111 overall and reducing the residual surface pores by increasing the pressure of the press in the manufacturing process in order to prevent the leakage of lubricating fluid and the reduction/diffusion of the pressure. When the internal density is increased in the vicinity of the internal periphery of the sleeve, which has a short axial length, until substantially equal to the density of the metal powder itself, compression is essentially not possible even if pressured is further applied to the mold. Therefore, even if an attempt is made to forcibly increase the pressure of the press, not only will the internal density inside the sleeve not increase, but the mold may also be damaged in the vicinity of internal portion of the sleeve in which the internal density is greatest.

In machining a sleeve made of an ordinary sintered material, a sleeve blank is molded, compression is thereafter partially applied, and plastic deformation is carried out by the sizing process so that the pore diameter and steps achieve a predetermined dimensional precision. In this case, when the volume density of the portion to be machined becomes close to 100%, the pressure of the press must be extremely high in order to plastically machine the portion to be machined. As a result, the machining precision is degraded, the surface roughness is worsened, and in the case of an iron material, it is difficult to form a hydrodynamic groove by rolling or the like.

An object of the present invention is to provide a readily obtainable predetermined shape precision in the compression-molding of a sleeve having a plurality of step portions, wherein the average density is substantially constant throughout the entire sleeve, residual pores having a size that is problematic in terms of bearing performance cannot be formed in the surface of the sintered material, and considerable pressure does not have to be applied to the press. As a result, oil leakage and pressure reduction/diffusion are prevented, and it is possible to provide a hydrodynamic bearing device, and spindle motor and an information device provided with the hydrodynamic bearing device, in which the required bearing precision and needed performance are satisfied.

The hydrodynamic bearing device according to a first aspect of the present invention comprises a sleeve, a shaft, a bearing portion, a hydrodynamic groove, a concavity having one or more steps, a convexity, and a lubricating fluid. The sleeve is composed of a sintered material and has a compression-absorbing space inside the sleeve, the sleeve having a bearing hole in a center of the sleeve. The shaft is rotatably inserted into the bearing hole. The bearing portion is formed between the bearing hole and the shaft. The hydrodynamic groove is formed on at least one of an internal peripheral surface of the bearing hole and an external peripheral surface of the shaft. The concavity has one or more steps formed on one end of the sleeve in an axial direction of the sleeve. The convexity is formed on the other end of the sleeve in the axial direction, and has a shape similar to the concavity. The lubricating fluid is filled in a gap of the bearing portion.

It is preferred that the concavity and the convexity have substantially the same volume.

The hydrodynamic bearing device according to a second aspect comprises a sleeve, a shaft, a bearing portion, a hydrodynamic groove, and a lubricating fluid. The sleeve is composed of a sintered material and has a compression-absorbing space inside, the sleeve having a bearing hole in a center of the sleeve. The shaft is rotatably inserted into the bearing hole. The bearing portion is formed between the bearing hole and the shaft. The hydrodynamic groove is formed on at least one of an internal peripheral surface of the bearing hole and an external peripheral surface of the shaft. The lubricating fluid is filled in a gap of the bearing portion. The sleeve furthermore has a plurality of step regions arranged in a radial direction of the sleeve, and satisfies the expression (Lmax−Lmin)/Lmax≦P1, where P1 is a predetermined maximum step ratio, and, with reference to the plurality of step regions, Lmax and Lmin are maximum and minimum values, respectively, of the axial lengths of the step regions which have widths in the radial direction equal to or greater than a predetermined radial width Wr.

It is preferred that the predetermined radial width Wr be the larger of 0.2 mm and 10% with respect to a total radial direction width W of the sleeve that is from an innermost periphery to an outermost periphery of the sleeve; and the predetermined maximum step ratio P1 be 25%.

It is furthermore preferred that the sleeve further satisfy the expression |Li−Lj|/max (Li, Lj)≦P2, where P2 is a predetermined adjacent step ratio, and, with reference to the plurality of step regions, Li and Lj are the respective axial lengths of two adjacent step regions among the step regions which have widths in the radial direction equal to or greater than the predetermined radial width Wr.

According to this aspect, it is preferred that the predetermined radial width Wr be the larger of 0.2 mm and 10% with respect to a total radial direction width W of the sleeve that is from an innermost periphery to an outermost periphery of the sleeve; the predetermined maximum step ratio P1 be 35%; and the predetermined adjacent step ratio P2 be 15%.

The hydrodynamic bearing device according to a third aspect comprises a sleeve, a shaft, a bearing portion, a hydrodynamic groove, and a lubricating fluid. The sleeve is composed of a sintered material and has a compression-absorbing space inside the sleeve, the sleeve having a bearing hole in a center of the sleeve. The shaft is rotatably inserted into the bearing hole. The bearing portion is formed between the bearing hole and the shaft. The hydrodynamic groove is formed on at least one of an internal peripheral surface of the bearing hole and an external peripheral surface of the shaft. The lubricating fluid is filled in a gap of the bearing portion. The sleeve has a plurality of step regions arranged in a radial direction of the sleeve, and satisfies the expression |Li−Lj|/max (Li, Lj)≦P2, where P2 is a predetermined adjacent step ratio, and, with reference to the plurality of step regions, Li is the axial length of the step region which has a width in the radial direction less than a predetermined radial width Wr, and Lj is the axial length of the step region adjacent in the radial direction to the step region having the axial length Li.

According to this aspect, it is preferred that the predetermined radial width Wr be the larger of 0.2 mm and 10% with respect to a total radial direction width W of the sleeve that is from an innermost periphery to an outermost periphery of the sleeve; and the predetermined adjacent step ratio P2 be 50%.

The hydrodynamic bearing device according to a fourth aspect comprises a sleeve, a shaft, a bearing portion, a hydrodynamic groove, and a lubricating fluid. The sleeve is composed of a sintered material and has a compression-absorbing space inside the sleeve, the sleeve having a bearing hole in a center of the sleeve. The shaft is rotatably inserted into the bearing hole. The bearing portion is formed between the bearing hole and the shaft. The hydrodynamic groove is formed on at least one of an internal peripheral surface of the bearing hole and an external peripheral surface of the shaft. The lubricating fluid is filled in a gap of the bearing portion. The sleeve has a plurality of step regions arranged in a radial direction of the sleeve, and satisfies the expression |Li−Lj|/max (Li, Lj)≦P2, where P2 is a predetermined adjacent step ratio, and, with reference to the plurality of step regions, Li and Lj are the respective axial lengths of two adjacent step regions among the step regions which have widths in the radial direction equal to or greater than a predetermined radial width Wr.

According to this aspect, it is preferred that the predetermined radial width Wr be the larger of 0.2 mm and 10% with respect to a total radial direction width W of the sleeve that is from an innermost periphery to the outermost periphery of the sleeve; and the predetermined adjacent step ratio P2 be 10%.

The hydrodynamic bearing device according to a fifth aspect comprises a sleeve, a shaft, a bearing portion, a hydrodynamic groove, and a lubricating fluid. The sleeve is composed of a sintered material and has a compression-absorbing space inside the sleeve, the sleeve having a bearing hole in a center of the sleeve. The shaft is rotatably inserted into the bearing hole. The bearing portion is formed between the bearing hole and the shaft. The hydrodynamic groove is formed on at least one of an internal peripheral surface of the bearing hole and an external peripheral surface of the shaft. The lubricating fluid is filled in a gap of the bearing portion. The sleeve has a plurality of step regions arranged in a radial direction of the sleeve; and satisfies the expression |Li−Lj|/max (Li, Lj)*(Lmax−Lmin)/Lmax≦P3, where P3 is a predetermined step parameter, and with reference to the plurality of step regions, Li and Lj are the respective axial lengths of two adjacent step regions among the step regions which have widths in the radial direction equal to or greater than the predetermined radial width Wr, and Lmax and Lmin are maximum and minimum values, respectively, of the axial lengths of the step regions which have widths equal to or greater than a predetermined radial width Wr.

According to this aspect, it is preferred that the predetermined radial width Wr be the larger of 0.2 mm and 10% with respect to a total radial direction width W of the sleeve that is from an innermost periphery to an outermost periphery of the sleeve; and the predetermined step parameter P3 be 0.0525.

According to yet another sixth aspect of the present invention, there are provided a spindle motor provided with the hydrodynamic bearing device according to any of the aspects described above, and an information device provided with the spindle motor.

The shape of the sleeve composed of sintered material is specified as described above. Therefore, the axial length inside the sleeve no longer rapidly varies. Accordingly, the density of each part of the sleeve during compression-molding is substantially uniform and the sintered compact overall can be machined with high precision. Since a portion with dramatically low density is not present in the sintered compact, the generation of harmful residual surface pores can be reduced in a sintered compact having a step section. Furthermore, since a portion with dramatically high density is not present, it is possible to readily obtain a predetermined shape precision and surface roughness. Therefore, it is possible to prevent a reduction/diffusion of the pressure generated by the hydrodynamic groove, and to obtain a hydrodynamic bearing device in which high performance and low cost can be achieved without danger of lubricating fluid flowing out from residual surface pores even after long term use.

### BRIEF DESCRIPTION OF THE DRAWINGS

FIG. 1A is a cross-sectional view of a spindle motor in which the hydrodynamic bearing device of an embodiment of the present invention, and FIG. 1B is a cross-sectional view of an information device of the same embodiment;

FIG. 2 is a flowchart showing the process for manufacturing a sleeve of the same embodiment;

FIG. 3 is a drawing showing the sizing state of the sleeve of the same embodiment;

FIG. 4 is a drawing showing the pores of the sintered material;

FIG. 5 shows the relationship between the various porosities and the volume density of a sleeve composed an iron material;

FIG. 6 shows the relationship between the volume density and the pressure ratio of the press in the process for molding the sintered material;

FIG. 7 is a conceptual view showing the method for manufacturing a sleeve of the embodiment described above;

FIG. 8A is a cross-sectional view of the sleeve of the embodiment described above, and FIG. 8B is a schematic view showing the relationship between the regions of the sleeve;

FIG. 9 shows the relationship between the residual surface porosity and the maximum step ratio in the sleeve of the same embodiment;

FIG. 10 shows the relationship between the residual surface porosity and the adjacent step ratio in the sleeve of the same embodiment;

FIG. 11 shows the relationship between the adjacent step ratio and the maximum step ratio in the sleeve of the same embodiment;

FIG. 12 is a half cross-sectional view of the sleeve of modified example A of the same embodiment;

FIG. 13 is a cross-sectional view of the sleeve of modified example B of the same embodiment;

FIG. 14 is a half cross-sectional view of the sleeve of modified example C of the same embodiment;

FIG. 15 is a cross-sectional view of the spindle motor in which the hydrodynamic bearing device of modified example D of the same embodiment has been mounted;

FIG. 16 is a cross-sectional view of the sleeve of modified example E of the same embodiment;

FIG. 17 shows the relationship between the bearing service life ratio and the residual surface porosity in the sleeve of the same embodiment;

FIG. 18 is a cross-sectional view of the main constituent elements of a conventional hydrodynamic bearing device; and

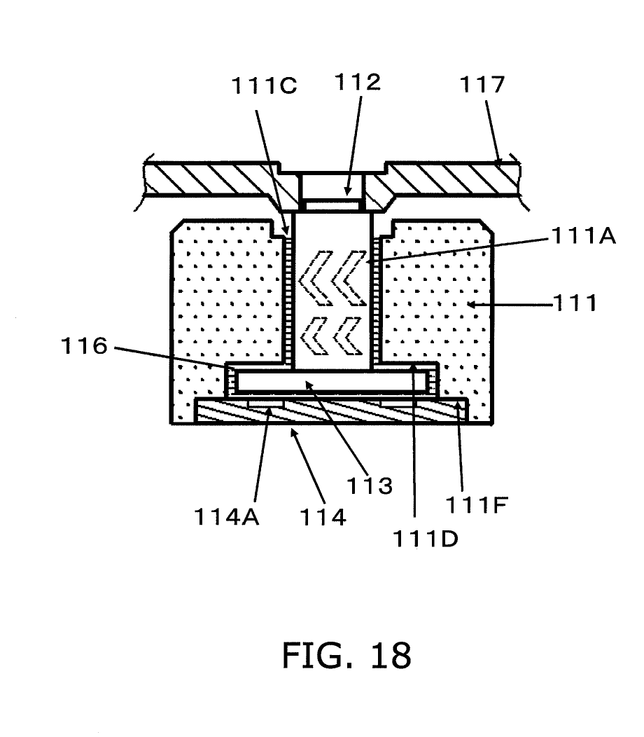

FIG. 19 is an enlarged view of the surface of the sintered material of a conventional hydrodynamic bearing device.

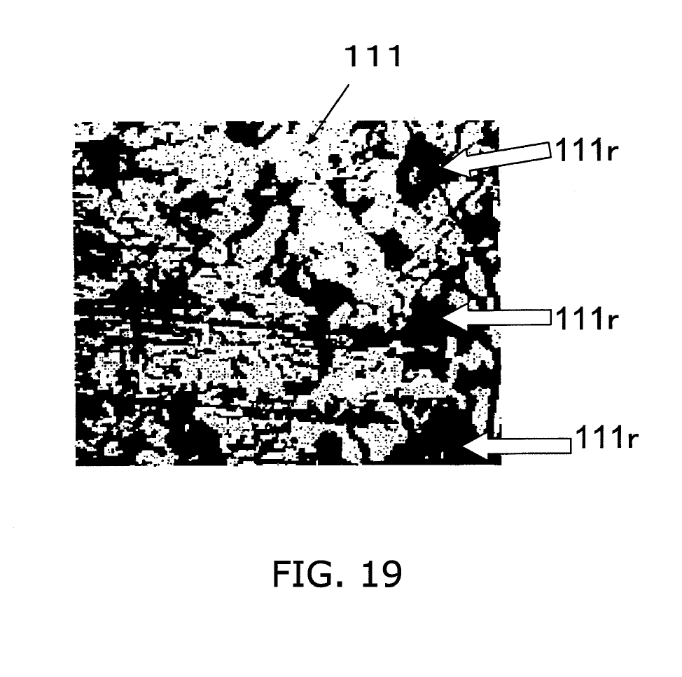

### DETAILED DESCRIPTION OF THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

The hydrodynamic bearing device according to an embodiment of the present invention and an information device provided therewith will be described below with reference to the diagrams.

### 1. Embodiments

### 1.1: Configuration

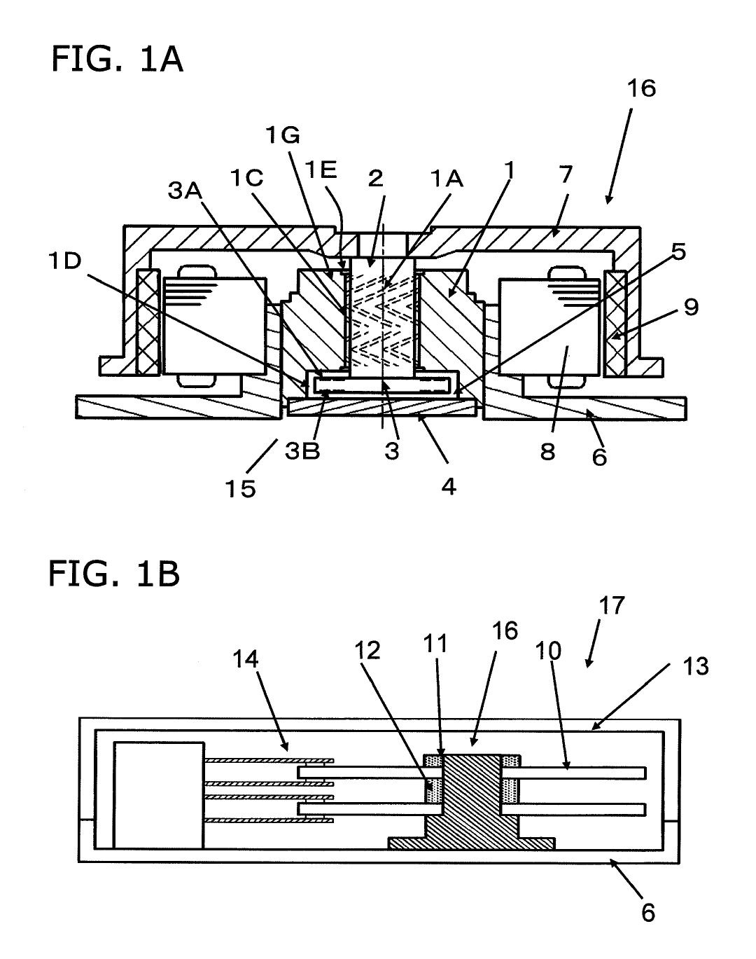

FIG. 1A is a cross-sectional view of a spindle motor 16 provided with a hydrodynamic bearing device 15 of the present embodiment.

<1.1.1: Configuration of the hydrodynamic bearing device 15>

The hydrodynamic bearing device 15 is provided with a substantially hollow cylindrical sleeve 1, a shaft 2, a flange 3, and a substantially disc-shaped thrust plate 4.

The sleeve 1 has a bearing hole 1C. The substantially columnar shaft 2 is inserted into the bearing hole 1C via a very small gap of about several microns, and the sleeve 1 and the shaft 2 are rotatably inserted into the bearing hole 1C.

The sleeve 1 ordinarily has one or two radial bearing surfaces inside the bearing hole 1C. The length of the bearing hole 1C is in a range of 3 mm to 20 mm. The outside diameter of the sleeve 1 is in a range of 6 mm to 12 mm. The sleeve 1 is manufactured by subjecting a powder material composed of iron, stainless steel, or a copper alloy to later-described compression molding and then to high-temperature sintering.

The shaft 2 is manufactured using stainless steel, high manganese-chromium steel, or carbon steel. The flange 3 is fixed to one end of the shaft 2, and the flange 3 is disposed in a concavity 1D of the sleeve 1. The flange 3 may be integrally machined with the shaft 2. The substantially disc-shaped thrust plate 4 is fixed to the lower end of the sleeve 1 by curling, bonding, curling and bonding, welding, or the like, so as to close off the concavity 1D.

A radial hydrodynamic groove 1A having a herringbone shape or the like is formed on the internal peripheral surface of the bearing hole 1C of the sleeve 1 and constitutes a radial bearing portion. Thrust hydrodynamic grooves 3A, 3B are formed on the surface of the flange 3 that faces the sleeve 1 in the axial direction and the surface of the flange 3 that faces the thrust plate 4 in the axial direction, respectively, and constitute a thrust bearing portion. The thrust dynamic groove 3A does not have to be formed. Oil, high-fluidity grease, an ionic fluid, or another lubricating fluid 5 is filled into at least the bearing gap in the vicinity of the hydrodynamic grooves 1A, 3A, 3B.

The shaft 2 has a diameter of 2.0 mm to 6.0 mm, and is designed to rotate in a range of 360 rpm to 15,000 rpm. In this case, the diameter precision of the bearing hole 1C and the perpendicularity of the concavity 1D must be on the order of 1 μm, for example, in order to obtain the required bearing performance.

The peripheral groove-shaped lubricating fluid (oil) reservoir 1E is formed in the aperture portion of the side opposite (above the FIG. 1A) from the concavity 1D of the sleeve 1 by forming a groove in the circumferential direction of the shaft 2 or the sleeve 1. The lubricating fluid reservoir 1E may be tapered that widens in diameter from the bearing hole 1C toward the opening portion.

The thrust dynamic groove 3A formed on the surface facing the flange 3 or the sleeve 1 in the axial direction is, e.g., a groove having a herringbone (fishbone-shaped pattern) or a spiral pattern (vortice-like pattern). The thrust hydrodynamic groove 3B formed on the surface facing the flange 3 or the thrust plate 4 in the axial direction is often a groove having a spiral pattern, but may also be a herringbone pattern.

### <1.1.2: Configuration of the Spindle Motor 16>

The spindle motor 16 is provided with the hydrodynamic bearing device 15, a base 6, a rotor hub 7, a stator 8, and a rotor magnet 9.

The hydrodynamic bearing device 15 is affixed to the base 6 by press-fitting, bonding, curling, welding, or other means, or by a suitable combination to these means. The rotor hub 7 having a lidded cylindrical shape is fixed to the other end of the shaft 2 of the hydrodynamic bearing device 15 by press-fitting, bonding, welding, or other means, or by a suitable combination to these means. The hollow cylindrical rotor magnet 9 is fixed to the rotor hub 7. The stator 8 having a plurality of salient poles on the external peripheral side and on which a coil is wound is disposed facing the rotor magnet 9. The rotary portion composed of the shaft 2, the flange 3, the rotor hub 7, and the like is configured so as to be drawn toward the base 6 by the magnetic force or the like between the rotor magnet 9 and the stator 8.

The spindle motor 16 provided with the hydrodynamic bearing device 15 is configured in the manner described above.

### <1.1.3: Configuration of the Information Device 17>

FIG. 1B is a cross-sectional view of the information device 17 provided with the spindle motor 16.

The information device 17 is, e.g., a hard disk device, an optical drive device, a polygonal mirror scanner device, or the like. The hard disk device will be described as an example below, but the present invention is not limited to a hard disk device.

A disk 10 is fixed to the rotor hub 7 of the spindle motor 16 via a clamp member 11, a spacer 12, and the like, as shown in FIG. 1B. A head actuator unit 14 on which a magnetic head or the like is mounted is fixed to the base 6 via a screw or the like, and these components are hermetically sealed by a cover 13 and constitute the information device 17.

### 1.2: Operation

The operation of the hydrodynamic bearing device 15 and the spindle motor 16 configured in the manner described above will be described.

A rotating magnetic field is generated when the coil wound around the stator 8 is energized, and magnetic power is imparted to the rotor magnet 9. The rotor magnet 9 starts rotating together with the rotor hub 7, the shaft 2, the flange 3, the disk 10, and the like (these are hereinafter referred to as rotation portion).

The rotation causes the dynamic grooves 1A, 3A, 3B to gather the lubricating fluid 5 and generate a pumping force between the shaft 2 and the sleeve 1, between the flange 3 and the sleeve 1, and between the flange 3 and the thrust plate 4. The rotating portion is thereby made to float and the shaft 2 is made to rotate in a non-contacting state with the sleeve 1 and the thrust plate 4.

The information device 17 records and reproduces data, information, and the like to and from the rotating disk 10 by using a magnetic head or an optical head (not shown).

### 1.3: Sleeve 1 Machining Process

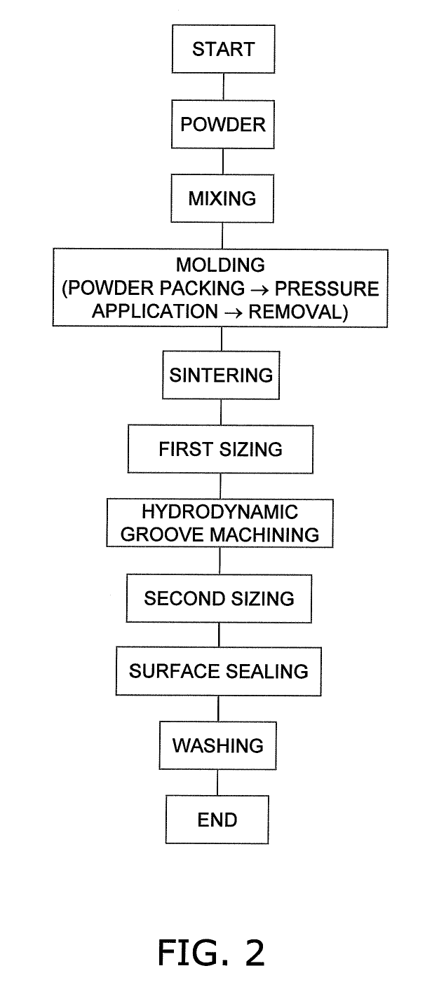

FIG. 2 is an example of the flowchart showing the machining process of a sleeve for a hydrodynamic bearing made of a sintered material. As shown in the flowchart, a metal powder containing iron or copper is mixed, poured into a mold (powder packing), and pressure is applied to obtain a predetermined sleeve shape. The pressed powder is thereafter removed from the mold, heated to a predetermined temperature, and sintered to obtain a sintered article.

The sizing step and the hydrodynamic groove machining step are then carried out a plurality of times in order to assure the inside diameter precision, cylindricity, circularity, surface roughness, and the like of the bearing hole 1C constituting the radial bearing portion, and the perpendicularity, the flatness, and the precision of other shape dimensions of the concavity 1D to which the thrust plate 4 is fixed.

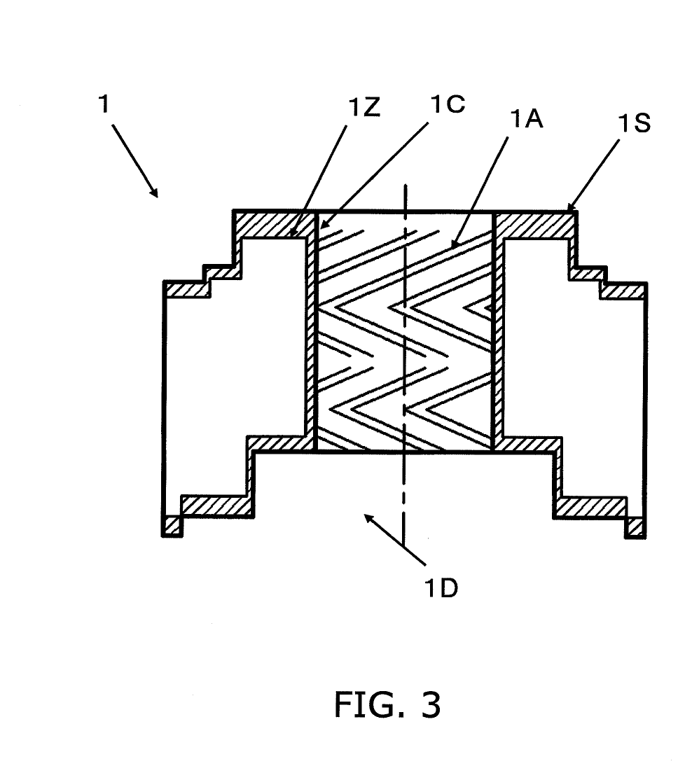

As a result, the shaded region is compressed to an initial shape 1S, and the final shape 1Z can be obtained, as shown in FIG. 3. The hydrodynamic groove machining is carried out using common mechanical machining techniques mainly referred to as ball rolling and mold transfer.

A surface sealing operation is furthermore carried out as needed. The surface sealing operation is a step for eliminating very small though-pores that remain in the surface of the sintered material (the pores will be described later).

A first method may be a method for embedding resin or metal in the residual surface pores, a method for forming a hard oxide coating by subjecting the surface to a steam treatment or the like, a method for embedding residual surface pores by plating, or another method.

In the first method, the sleeve 1 may be formed using, e.g., a sintered alloy containing 90% or more of iron as the material and forming a coating composed of tetrairon trioxide or a triiron dioxide on the surface using a steam treatment. It is possible to achieve a predetermined level of wear resistance in a sleeve 1 manufactured in this manner.

A second method may be a method in which sizing pins are forcibly pressed into the internal peripheral surface of the sintered material to create a plastic flow on the surface and cover the surface pores; or the second method may be another method.

The surface sealing operation is carried out using any one or a combination of any number of the methods.

Washing is thereafter carried out to complete the sleeve 1.

A roughening operation is preferably carried out so that the surface roughness of the radial bearing surface of the sleeve 1 is in a range of 0.01 to 1.60 μm. The shaft 2 is machined to a surface roughness in the range of 0.01 to 0.2 μm to obtain a predetermined wear resistance. The surface roughness is measured using a calculated average roughness Ra (cutoff value setting: 0.25 mm) with the aid of a surface roughness meter, or using a 10-point average roughness Rx JIS (JIS-B0601:1994).

### <<Residual Pores of the Sintered Compact>>

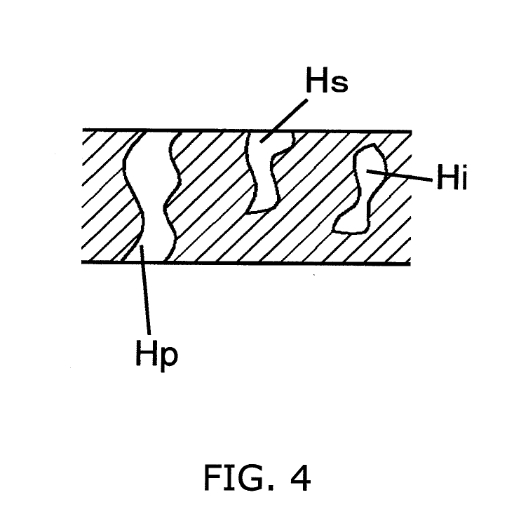

The surface and interior of the sintered metal is generally porous. There are three types of these very small pores (air pores): through-pores Hp, internal pores Hi, and surface pores Hs, as shown in FIG. 4. The through-pores Hp are formed when the high-pressure generating ridge portions connect to low-pressure groove portions, when very small pores connect together from the internal periphery to the external periphery of the sleeve, or in other cases. The surface pores Hs are substantially round concavities or striped concavities having a depth of about several μm that are left on the surface. The internal pores Hi are pores closed inside the sintered compact.

The internal pores Hi are not connected to the surface and therefore do not present a danger of reducing the pressure generated by the hydrodynamic grooves and are not the source of lubricating fluid leakage. The internal pores Hi do not affect in any way the performance of the hydrodynamic bearing-type rotary device. However, after the sintered compact has been formed, the internal pores Hi must be left behind in order to obtain a predetermined shape precision in the sizing operation and to form hydrodynamic grooves by rolling or the like. A predetermined amount of the internal pores are left behind and the pores therefore act as compression-absorbing space during sizing or the like and machining is facilitated. Also, shape precision is increased and the surface roughness of the bearing surface or the like can be enhanced. As described hereinbelow, the mold conditions are ideally set so that the internal porosity is about 2% to about 8% at the point when the sleeve has been completed.

In the hydrodynamic bearing device 15, two types, i.e., the through-pores Hp and the surface pores Hs are problems in terms of oil leakage and pressure reduction/diffusion. In other words, the lubricating fluid leaks when through-pores Hp are left behind. Also, when residual surface pores such as the through-pores Hp and the surface pores Hs are present, the same effect occurs as when the average bearing gap has increased in terms of appearance in the bearing portion, and the pressure generated by the hydrodynamic grooves of the hydrodynamic bearing device is liable to be reduced or diffused. Therefore, the open pores (Hp+Hs), which is the sum of the through-pores Hp and the surface pores Hs, must be reduced in order to use the sintered sleeve in a hydrodynamic bearing device.

The open porosity is calculated using the ratio (volume percentage) of the open pores (Hp+Hs) in relation to the entire sleeve volume. However, the depth of the surface pores Hs is about several microns and the volume thereof is less by two decimals or more in comparison with the volume of the through-pores Hp. Therefore, the open porosity can be viewed to be substantially the same as the through-porosity.

The open porosity (Hp+Hs) is calculated in the following manner using “JIS-Z-2501: 2000 Sintered Metal Material—Determination of Density, Oil Content, and Open Porosity.”

After the mass of the clean and completely degreased sintered compact has been measured, complete impregnation is carried out using a vacuum pressure impregnation device to measure the mass of the sintered compact following impregnation. The volume of the open porosity (Hp+Hs) can be measured by dividing the mass difference after impregnation by the density of the oil content. The open porosity can be measured by dividing the volume of the open porosity (Hp+Hs) by the apparent volume of the sintered sleeve. The open porosity can be viewed essentially as the through-porosity.

The surface porosity is measured in the following manner.

The through-pores Hp and the surface pores Hs of the clean and completely degreased sintered compact are impregnated with resin. Only the resin of the surface pores Hs is then washed away using a suitable solvent, the resin is left only in the through-pores Hp, the resin is solidified, and the mass m1 is measured. In this state, the difference (m2−m1) from the mass m2 after the lubricating fluid has been applied by vacuum lubrication is calculated, and this difference is divided by the specific gravity ρ of the lubricating fluid to obtain a volume ΔVs that corresponds to the surface pores Hs. Therefore, the surface porosity is calculated as the ratio of ΔVs to the apparent volume Va11 of the sleeve 1.

However, the procedure for measuring the surface porosity alone in the manner described above is laborious, and it is difficult to measure with good precision. Therefore, the surface area ratio of the residual surface pores in the surface of the sintered compact is ordinarily calculated rather than the volume of the surface pores to determine the size of the residual surface pores. The residual surface porosity (surface area percentage) is determined by measuring the surface area ratio of the pores per unit surface area by microscopy or photography, or by video camera or another imaging technique.

The total porosity, which is the ratio of the total volume of the three types of pores (through-pores Hp, internal pores Hi, surface pores Hs) to the apparent volume, can be uniquely obtained from the apparent volume density of the sleeve and the average density of the sintered metal power using the specific weight method.

The apparent volume density of the sintered sleeve is obtained by dividing the mass of the degreased sleeve by the apparent volume Va11 calculated from the external shape of the sleeve. For example, in the case of an iron-based metal sintered compact having a true density of 7.84/cm³, the total porosity including the internal porosity Hi would be 0% when apparent volume density is 7.84 g/cm³.

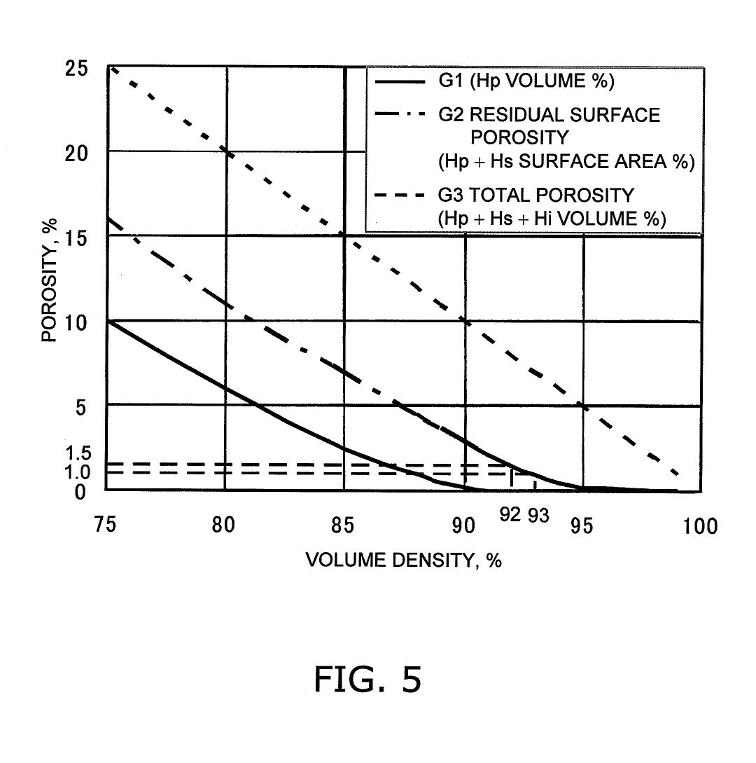

FIG. 5 shows the relationship between the porosities and the volume density of the sleeve 1 composed an iron material. The curve G1 in the graph is the through-pores (Hp) and the volume ratio. The curve G2 is the residual surface porosity (through-pores Hp+surface pores Hs). The curve G2 is a surface area ratio. The curve g3 is the total porosity (through-pores Hp+surface pores Hs+internal pores Hi).

G2 (residual surface porosity: surface area percentage) is 5% or less when the volume density is 90% or higher, as shown in FIG. 5. Also, G2 (residual surface porosity: surface area percentage) is 1.5% or less when the volume density is 92% or higher. Furthermore, G2 (residual surface porosity: surface area percentage) is 1% or less when the volume density is 93% or higher. The through-porosity (G1) is essentially 0 when the volume density is 90% or higher.

In other words, the internal porosity (Hi) is essentially equal to the total porosity (Hp+Hs+Hi) when the volume density is 90% or higher. The through-porosity following sizing in the flowchart of the manufacturing process shown in FIG. 2 can thus be brought to 0, and the residual surface porosity can thus be brought to 1.5% or less or 1% or less by setting the volume density to 92% or higher or 93% or higher (i.e., bringing the internal porosity to 8% or less and more preferably to 7% or less). Therefore, leakage of the lubricating fluid from the sleeve 1 and reduction/diffusion of the hydrodynamic pressure can be prevented.

It is apparent that the internal porosity is preferably set to 1% or higher when consideration is given to precision, roughness, and other parameters during sizing. The internal peripheral surface of the bearing hole 1C can thus be efficiently machined by setting the internal porosity 1% to 8%. A smooth mirror-like surface can be achieved, lubricating fluid does not leak out, and an optimal sleeve for a bearing can be obtained. Since machining is facilitated, problems related to mold damage and abrasion can be avoided.

The residual surface pores improve to a value near 0 following the surface sealing treatment step shown in FIG. 2 and the reduction/diffusion of hydrodynamic pressure can be essentially eliminated.

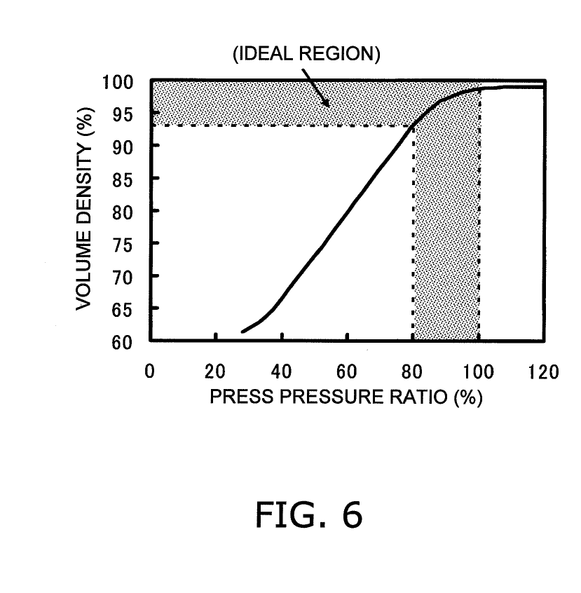

FIG. 6 shows the relationship between the volume density of the sintered material and the pressure ratio (%) of the press in the process for molding the sintered material. In the graph, the numerical value (%) of the press pressure ratio is no more than a magnitude correlation and 0% on the scale is 0 ton/cm². The scale at 100% is defined at the press pressure that has reached the upper limit (99% to 100%) in which the volume density does not further increase. The pressure of the press is generally a value in the range of about 5 to 20 ton/cm².

In FIG. 5, it is shown that the residual surface porosity can be set to 1% or less by bringing the volume density of the sintered material to 93% or higher, but it is also shown that this can be achieved with a press pressure ratio of 80% or higher, as shown in FIG. 6. In other words, setting the pressure of the press to 80% or higher and less than 100% achieves optimal machining conditions in which the density of the sintered material is 93% or higher, the residual surface porosity is minimal or 0, there is at the same time no concern that the mold will be damaged from excessive press pressure, and following sizing the shape precision is high and surface rough is good.

### <<Compression-Molding Step of the Sleeve 1>>

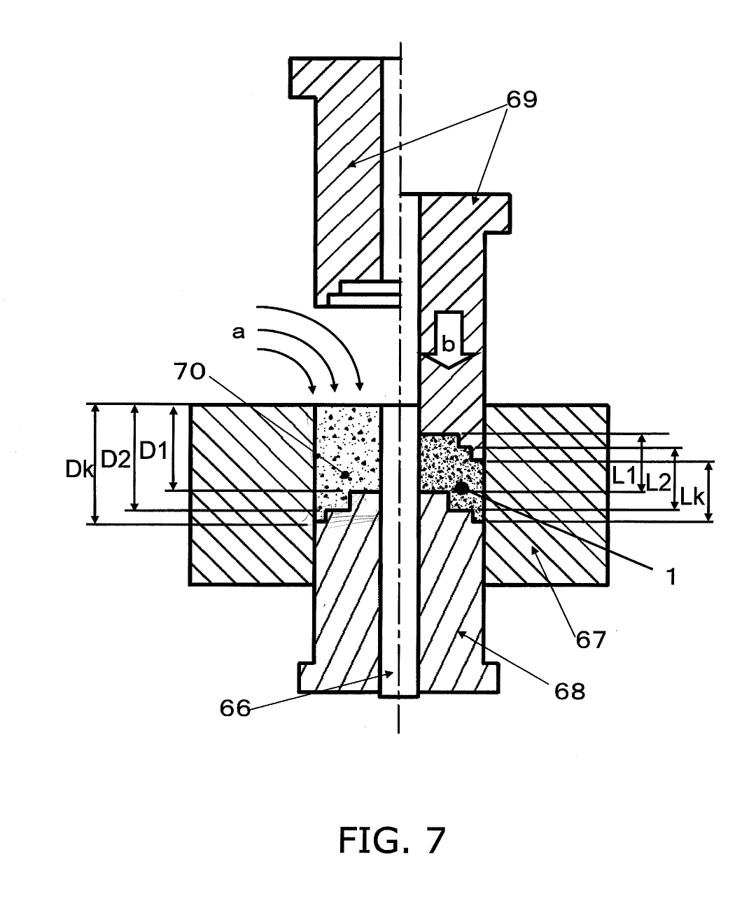

FIG. 7 is a conceptual view of the step compression-molding in a mold the sleeve 1 having a plurality of step sections.

In the left half of FIG. 7, a lower mold 68 is slidably mounted in the empty space between a mold pin 66 and an external peripheral mold 67, and an upper mold 69 is coaxially positioned above the lower mold. Here, the empty space has step sections in which the depths D1, D2, . . . , Dk (outermost portion) are arranged in sequence from the internal peripheral side. A mixed powder 70 is poured into the empty space until the same height as the upper surface of the external peripheral mold is reached, as shown in the drawing.

Next, the upper mold 69 is inserted into the external peripheral mold 67 in the direction of the arrow b in the drawing, as shown in the right half of the drawing. The powder 70 is compressed until the axial length reached L1, L2, . . . , Lk in sequence from the internal peripheral side. In the initial step of compression, the gaps between the particles of the powder 70 are relatively large. Therefore, the particles of the powder 70 flow slightly so as to conform to the lower end surface shape of the upper mold 69. After compression has progressed and the gaps between the powder 70 have narrowed, the particles substantially stop flowing and the gaps between the particles are reduced. In this manner, particles adhere to each other and are molded.

In the example shown in FIG. 7, the powder 70 is poured onto the lower mold 68 having the step sections, and the lower mold 68 is lowered from above to compress and mold the powder 70. However, the following step may be carried out in lieu of the above. First, a lower mold without step sections is used, and the powder 70 is poured onto the horizontal upper end surface of the lower mold and then baked and solidified. The cylindrically-shaped sintered compact formed in this manner is compressed and molded by upper and lower molds having step sections as shown in FIG. 7. In this step, the powder 70 is solidified into a cylindrical shape prior to being compressed and molded by upper and lower molds having step sections. Therefore, it is possible to prevent the particles of the powder 70 prior to compression and molding from flowing due to the step sections of the mold, and the density can be prevented from varying. The volume density of the molded sleeve 1 can thereby be made even more uniform.

In this case, the ratio U of mold internal pressure to compression length in the compression-molding step is defined in the following manner for each step section.

U1=D1/L1, U2=D2/L2, . . . , Uk=Dk/Lk

When the ratio U of mold internal pressure to compression length differs dramatically depending on the location, the volume density becomes nonuniform, and as a result, residual pores are generated in low density areas, the hydrodynamic pressure is diffused, and the lubricating fluid leaks.

The compression ratio after flow has ended in the initial stage after compression has started may be a predetermined value or higher overall in order to achieve a uniform density overall to an extent that the bearing performance is not affected, even in locations where the volume density is lowest after the sleeve 1 has been molded.

### 1.4: Shape of the Sleeve 1

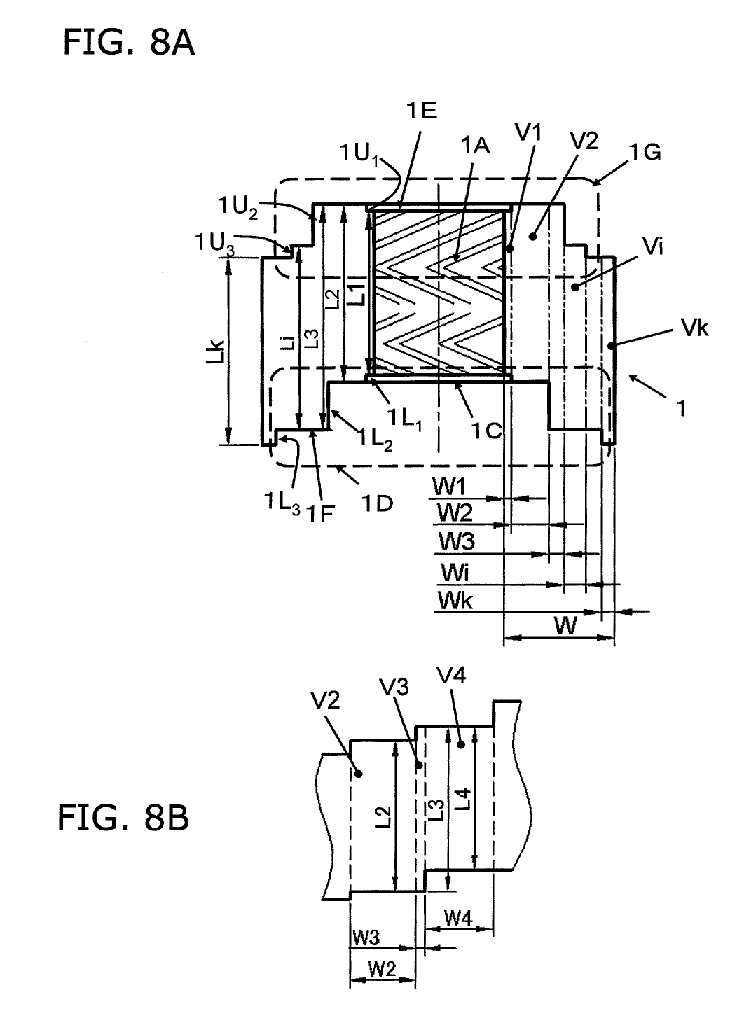

The shape of the sleeve 1 is described in detail below with reference to FIG. 8A. FIG. 8A is a cross-sectional view of the sleeve 1 in the present embodiment. The sleeve 1 is composed of a sintered material having internal pores.

The sleeve 1 is sectioned into step regions having substantially the same axial length, as shown in FIG. 8A. There are k step regions formed in the radial directions. The step regions are referred to as V1, V2, . . . , Vi, . . . , Vk. The lengths of these step regions in the axial direction are L1, L2, . . . , Li, . . . , Lk, respectively. Also, the widths of the step regions in the radial direction are W1, W2, . . . , Wi, . . . , Wk, respectively. W is the width in the entire radial direction from the outermost periphery of the sleeve 1 to the innermost periphery. The optimal shape of the sleeve is described below for various cases.

### <1.4.1: Shape Examples of the Sleeve 1>

### SHAPE EXAMPLE 1

The sleeve 1 has a concavity 1D with one or more steps at one end in the axial direction of the sleeve, has a shape at the other end in the axial direction similar to the concavity 1D, and has a convexity 1G with substantially the same volume. In this case, the phrase “similar shape” includes the case in which the convexity 1G has a shape that is similar to the complementary shape of the concavity 1D, as shown in FIG. 1A, for example.

More specifically, the concavity 1D is composed of step portions 1L1, 1L2, 1L3, and the convexity 1G is composed of step portions 1U1, 1U2, 1U3. The axial length of each step, i.e., step portions 1L1, 1L2, 1L3, 1U1, 1U2, 1U3 is 30% or less with respect to the entire length of the sleeve. The volume V_{D} of the concavity 1D and the volume V_{G} of the convexity 1G are set so that the following relational expression (1) holds true.

$$\begin{matrix}Formula 1 & \\ \frac{1}{Pv} \leq \frac{{V}_{D}}{{V}_{G}} \leq Pv & ( 1 )\end{matrix}$$

In the formula, Pv is 1.5. In other words, the volume is limited so that the volume V_{D} of the concavity 1D and the volume V_{G} of the convexity 1_{G} are mutually within ±50%. In this manner, the concavity 1D for constituting the bearing is provided at one end of the sleeve 1 and the convexity 1G similar to the concavity 1D is provided at the other end, whereby the axial length Li in arbitrary step regions Vi of the sleeve 1 can be made adjacent to substantially the same value regardless of the location. As a result, it is possible to reduce the occurrence of portions in which the volume density is inordinately nonuniform in the sleeve 1. When Pv is set to 1.3, the volume difference is reduced, so a more preferable result can be obtained.

### SHAPE EXAMPLE 2

The shape of the sleeve 1 is set so that the following relational expression (2) holds true.

$$\begin{matrix}Formula 2 & \\ \frac{( L max - L min )}{L max} \leq P 1 & ( 2 )\end{matrix}$$

The left side of the relational expression (2) is the maximum step ratio. The maximum step ratio is the maximum difference in axial length between step regions having a predetermined radial width or greater.

In the expression, Lmax and Lmin are set in the following manner. All of the step regions Vi in which the radial width Wi is a predetermined radial width Wr or greater are extracted within the k step regions described above, and Lmax and Lmin are set as the maximum value and the minimum value, respectively, of the axial length Li.

The predetermined radial width Wr is the larger of 0.2 mm and 10% of the total radial width W. More preferably, the predetermined radial width Wr is the larger of 0.1 mm and 5% of the total radial width W.

P1 on the right side of the relational expression (2) is the maximum step ratio described above, and is preferably set to 25%. The maximum step ratio P1 is more preferably set to 20%.

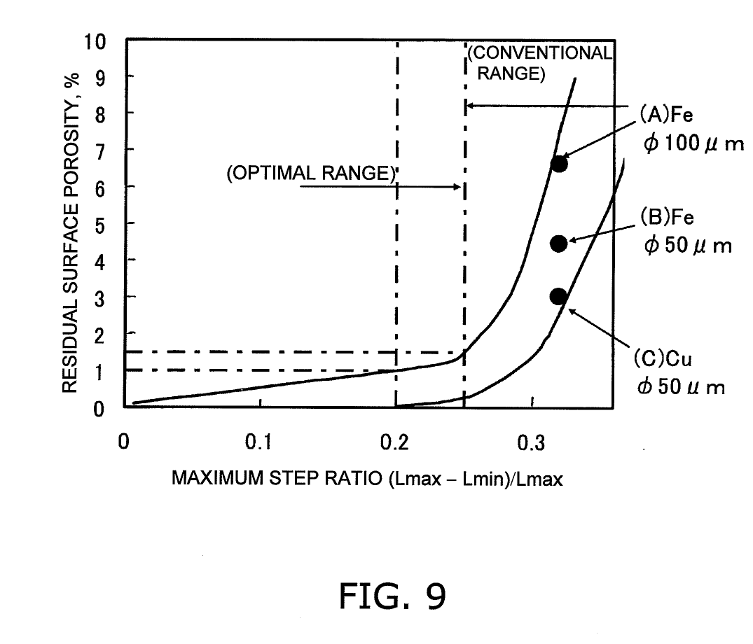

FIG. 9 shows the relationship between the measured values of the residual surface porosity and (Lmax−Lmin)/Lmax. The pressure ratio during press machining was carried out at a fixed value of 80%, as shown in FIG. 6. It is apparent as a result that the residual surface porosity of the surface of the sintered material prior to the surface sealing operation in the flowchart of FIG. 2 can be brought to 1.5% or less when the (Lmax−Lmin)/Lmax is 0.25 or less. An internal porosity of 1% or higher can be assured even in locations where the volume density is highest. The residual surface porosity can be brought to 1% or less when the (Lmax−Lmin)/Lmax is 0.2 or less. An internal porosity of 2% or higher can be assured even in locations where the volume density is highest.

In the case that a powder having a large particle diameter in an iron-based material is used, the surface roughness of the sintered material after the molding operation is poor, and the residual surface porosity increases prior to the surface sealing operation. On the other hand, a copper-based material has good moldability in press machining, and the surface porosity becomes very low when a powder having a small particle diameter is used. A powder composed of pure iron or an iron-based material having a small particle diameter exhibits moldability and residual surface porosity that lies between the two materials described above.

The residual surface porosity is improved to a numerical value near 0% after the surface sealing treatment step using any of the method described above with reference to FIG. 2.

The axial length Li in any of the step regions Vi of the sleeve 1 can thus be brought near to substantially the same value regardless of the location by setting the difference between the maximum value Lmax and the minimum value Lmin to be less than the maximum step ratio P1. As a result, the occurrence of portions having an extremely low volume density in the sleeve 1 can be reduced.

### SHAPE EXAMPLE 3

The shape of the sleeve 1 is set so that the relational expression (2) noted above and the relational expression (3) shown below simultaneously hold true.

$$\begin{matrix}Formula 3 & \\ \frac{\vert Li - Lj \vert}{max ( Li , Lj )} \leq P 2 & ( 3 )\end{matrix}$$

In the formula, max(Li, Lj) refers to the larger of Li and Lj.

As described above, the left side of the relational expression (2) is the maximum step ratio and corresponds to the maximum difference in the axial length between the step regions having a predetermined radial width or greater.

As described above, Lmax and Lmin are set in the following manner. All of the step regions Vi in which the radial width Wi is a predetermined radial width Wr or greater are extracted within the k step regions described above, and Lmax and Lmin are set as the maximum value and the minimum value, respectively, of the axial length Li.

P1 in relational expression (2) is the maximum step ratio, and is 35% in the present shape example.

On the other hand, the left side of the relational expression (3) is the adjacent step ratio. The adjacent step ratio corresponds to the difference (absolute value) in axial length between mutually adjacent step regions having a predetermined radial width or greater.

P2 in relational expression (3) is the adjacent step ratio and is 15%.

Li, Lj are set in the following manner. First, all of the step regions Vi in which the radial width Wi is a predetermined radial width Wr or greater are extracted within the k step regions described above. Next, the step region Vj adjacent to the external peripheral side or to the internal peripheral side in the radial direction in relation to the step regions Vi is selected from the extracted group of step regions. In other words, the radial width Wj of the step region Vj is also a predetermined radial width Wr or greater. Li, Lj are defined as the axial lengths of such step regions Vi, Vj, respectively.

The predetermined radial width Wr is the larger of 0.2 mm and 10% of the total radial width W. More preferably, the predetermined radial width Wr is the larger of 0.1 mm and 5% of the total radial width W.

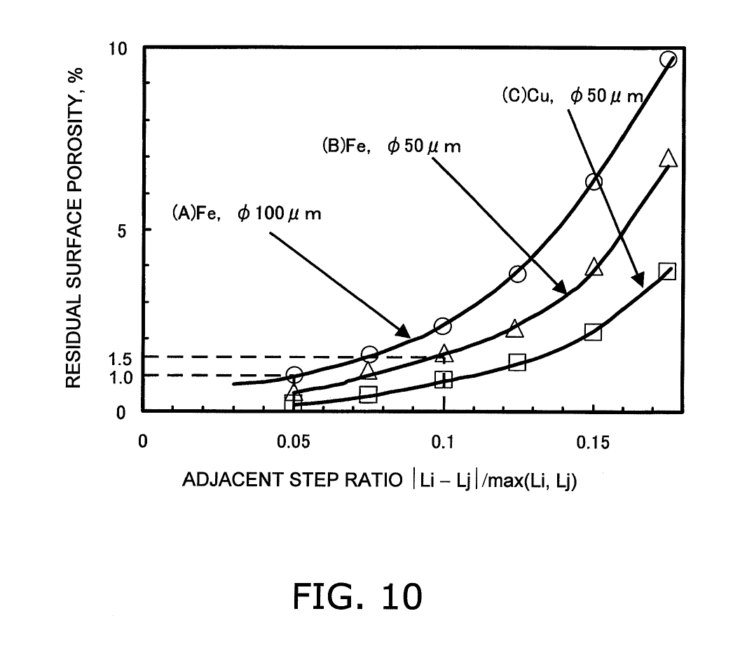

FIG. 10 shows the relationship between the adjacent step ratio and the residual surface porosity (surface area %). The particle diameter is 50 μm or less when the metal powder is copper- or iron-based, as shown in graph. The residual surface porosity can be set to 1.5% when the adjacent step ratio is 0.1 or less. The residual surface porosity can furthermore be set to 1% or less when the adjacent step ratio is 0.05 or less. In this manner, the residual surface porosity can be kept to a low value in the case that the particle diameter of the metal powder is small, even when the adjacent step ratio is high.

Considered below are a case in which a step region V3 having a narrow radial width is present between the step region V2 and the step region V4, and a case in which the step region V2 is set as a step region Vi, as shown in FIG. 8B. In this case, the step region V3 is not considered to be the adjacent region Vj of a step region Vi (step region V2, in this case), and the step region V4 is considered to be the adjacent region Vj of the step region V2. This is because the step region V3 is very narrow, even if the axial length L3 of the step region V3 varies considerably with respect to the axial lengths L2, L4 of the adjacent step regions V2, V4, and the effect is therefore very small without extreme variation in the density of the metal powder for sintering. The shape conditions related to such a narrow step region are described later.

Rapid variations in axial length can be reduced in the sleeve 1 by setting the difference between the axial lengths Li, Lj of mutually adjacent step regions Vi, Vj to be less than the predetermined adjacent step ratio P2, and by setting the difference between Lmax and Lmin to be less than the maximum step ratio P1. As a result, it is possible to reduce the occurrence of portions in the sleeve 1 in which the volume density is extremely nonuniform.

### SHAPE EXAMPLE 4

The shape of the sleeve 1 is set so that the relational expression (3) holds true.

In the formula, max(Li, Lj) refers to the larger of Li and Lj.

P2 in relational expression (3) is the adjacent step ratio, and is 50% in the present shape example 4.

Li, Lj are set in the following manner. First, the step regions Vi in which the radial width Wi is less than a predetermined radial width Wr are extracted within the k step regions described above. Next, the step region Vj adjacent to the external peripheral side or to the internal peripheral side in the radial direction in relation to the step regions Vi is selected. Here, the magnitude of the radial width Wj of the step region Vj does not matter. Li, Lj are defined as the axial lengths of such step regions Vi, Vj, respectively.

The predetermined radial width Wr is the larger of 0.2 mm and 10% of the total radial width W. More preferably, the predetermined radial width Wr is the larger of 0.1 mm and 5% of the total radial width W.

Considered below in the present shape example 4 is a case in which a step region V3 having a narrow radial width is present between the step region V2 and the step region V4, as shown in FIG. 8B. In this case, the step region V3 having a narrow radial width is considered to be a step region Vi, and the step regions V2 and V4 can be considered to be the adjacent region Vj of the step regions Vi (step region V3, in this case).

In contrast to shape example 3, the step regions Vi have a narrow radial width. Therefore, the effect is very small without extreme variation in the density of the metal powder for sintering even if the axial length Li of the step regions Vi varies considerably with respect to the axial length Lj of the adjacent step region Vj. Accordingly, the value of the adjacent step ratio P2 can be set to be greater than the case of shape example 3.

In this manner, rapid variations in axial length can be reduced in the sleeve 1 by setting the difference between the axial lengths Li, Lj of mutually adjacent step regions Vi, Vj to be less than the predetermined adjacent step ratio P2. As a result, it is possible to reduce the occurrence of portions in the sleeve 1 in which the volume density is extremely nonuniform.

### SHAPE EXAMPLE 5

The shape of the sleeve 1 is set so that the relational expression (3) holds true.

In the formula, max(Li, Lj) refers to the larger of Li and Lj.

In the same manner as described above, the left side of the relational expression (3) is the adjacent step ratio and corresponds to the difference (absolute value) in axial length between mutually adjacent step regions having a predetermined radial width or greater.

P2 in relational expression (3) is the adjacent step ratio and is 10% in the present shape example 5.

Li, Lj are set in the following manner. First, all of the step regions Vi in which the radial width Wi is a predetermined radial width Wr or greater are extracted within the k step regions described above. Next, the step region Vj adjacent to the external peripheral side or to the internal peripheral side in the radial direction in relation to the step regions Vi is selected from the extracted group of step regions. In other words, the radial width Wj of the step region Vj is also a predetermined radial width Wr or greater. Li, Lj are defined as the axial lengths of such step regions Vi, Vj, respectively.

The predetermined radial width Wr is the larger of 0.2 mm and 10% of the total radial width W. More preferably, the predetermined radial width Wr is the larger of 0.1 mm and 5% of the total radial width W.

Considered below are a case in which a step region V3 having a narrow radial width is present between the step region V2 and the step region V4, and a case in which the step region V2 is set as a step region Vi, as shown in FIG. 8B. In this case, the step region V3 is not considered to be the adjacent region of a step region Vi (step region V2, in this case), and the step region V4 is considered to be the adjacent region Vj of the step region V2. This is because the step region V3 is very narrow, even if the axial length L3 of the step region V3 varies considerably with respect to the axial lengths L2, L4 of the adjacent step regions V2, V4, and the effect is therefore very small without extreme variation in the density of the metal powder for sintering.

Rapid variations in axial length can be reduced in the sleeve 1 by setting the difference between the axial lengths Li, Lj of mutually adjacent step regions Vi, Vj to be less than the predetermined adjacent step ratio P2. As a result, it is possible to reduce the occurrence of portions in the sleeve 1 in which the volume density is extremely nonuniform.

### SHAPE EXAMPLE 6

The shape of the sleeve 1 is set so that the following relational expression (4) holds true.

$$\begin{matrix}Formula 4 & \\ \frac{\vert Li - Lj \vert}{max ( Li , Lj )} * \frac{( L max - L min )}{L max} \leq P 3 & ( 4 )\end{matrix}$$

The first half of the left side of the relational expression (4) is the adjacent step ratio and corresponds to the difference (absolute value) in axial length between mutually adjacent step regions having a predetermined radial width or greater. In this case, max(Li, Lj) refers to the larger of Li and Lj.

Li, Lj are set in the following manner. First, all of the step regions Vi in which the radial width Wi is a predetermined radial width Wr or greater are extracted within the k step regions described above. Next, the step region Vj adjacent to the external peripheral side or to the internal peripheral side in the radial direction in relation to the step regions Vi is selected from the extracted group of step regions. In other words, the radial width Wj of the step region Vj is also a predetermined radial width Wr or greater. Li, Lj are defined as the axial lengths of such step regions Vi, Vj, respectively.

The predetermined radial width Wr is the larger of 0.2 mm and 10% of the total radial width W. More preferably, the predetermined radial width Wr is the larger of 0.1 mm and 5% of the total radial width W.

Considered below are a case in which a step region V3 having a narrow radial width is present between the step region V2 and the step region V4, and a case in which the step region V2 is set as a step region Vi, as shown in FIG. 8B. In this case, the step region V3 is not considered to be the adjacent region of a step region Vi (step region V2, in this case), and the step region V4 is considered to be the adjacent region Vj of the step region V2. This is because the step region V3 is very narrow, even if the axial length L3 of the step region V3 varies considerably with respect to the axial lengths L2, L4 of the adjacent step regions V2, V4, and the effect is therefore very small without extreme variation in the density of the metal powder for sintering.

The second half of the left side of the relational expression (4) is the maximum step ratio and corresponds to the maximum difference in axial length between step regions having a predetermined radial width or greater. In the expression, Lmax and Lmin are set in the following manner. All of the step regions Vi in which the radial width Wi is a predetermined radial width Wr or greater are extracted within the k step regions described above, and Lmax and Lmin are set as the maximum value and the minimum value, respectively, of the axial length Li.

P3 of the right side of the relational expression (4) is a predetermined step parameter and is 0.0525. The predetermined step parameter is more preferably 0.04.

Rapid variations in axial length can be reduced in the sleeve 1 by setting the product of the maximum step of the axial length and the difference between the axial lengths Li, Lj of mutually adjacent step regions Vi, Vj to be less than the predetermined step parameter P3. As a result, it is possible to reduce the occurrence of portions in the sleeve 1 in which the volume density is extremely nonuniform.

As described above, the shape of a sleeve 1 made of a sintered material is specified, whereby the density of each part of the sleeve 1 is made uniform, all of the sintered material can be machined with high density, and the open porosity and residual surface porosity can be brought to a very low level. As a result, the pressure generated by the hydrodynamic grooves is not reduced/diffused on the surface of the sleeve, and the danger of the lubricating fluid 5 flowing from the residual pores is prevented even after long-term use. Since the machining precision of the bearing is high and the surface roughness can be kept low, the bearing stiffness is high and metal contact can be reliably prevented.

### <1.4.2: Optimum Range of the Shape of the Sleeve 1>

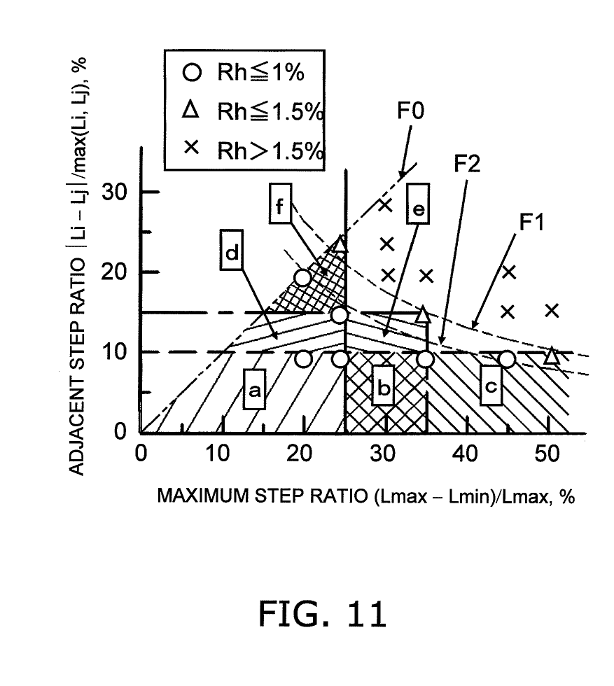

FIG. 11 is shows the result of experimentally confirming the affect on the residual surface porosity Rh when the maximum step ratio (Lmax−Lmin)/Lmax and the adjacent step ratio |Li−Lj|/max(Li, Lj) are varied. In the graph, the horizontal axis is the maximum step ratio and the vertical axis is the adjacent step ratio. The horizontal and vertical axes provide a plot of only the step regions having a radial width that is greater than the predetermined radial width Wr. The experiment was carried out using only a sleeve having at least one or more steps of 0.2 mm or greater.

In the graph, the straight line indicated by F0 is a straight line in which the maximum step ratio and the adjacent step ratio are equal. Therefore, only the lower right side of the straight line F0 need be considered.

The curved lines F1, F2 are curved lines in which the product of the maximum step ratio and the adjacent step ratio is a constant value, and are 0.0525 and 0.04, respectively.

In the graph, the residual surface porosity Rh increases upward to the right, and the residual surface porosity Rh conversely decreases downward to the left.

The residual surface porosity Rh is 1.5% or less when the maximum step ratio 25% or less (the shaded regions a, d, f of FIG. 11), as described in shape example 2, and the residual surface pores can be made smaller. The residual surface porosity Rh can be brought to 1% or less when the maximum step ratio is set to 20% or less.

The residual surface porosity Rh is 1.5% or less and the residual surface pores can be made smaller when the maximum step ratio is 35% or less and the adjacent step ratio is 15% or less (the shaded regions a, b, d, e), as described in shape example 3.

The residual surface porosity Rh is 1.5% or less and the residual surface pores can be made smaller when the adjacent step ratio is 10% or less (the shaded regions a, b, c), as described in shape example 5.

The residual surface porosity Rh is 1.5% or less and the residual surface pores can be made smaller when the product of the adjacent step ratio and the maximum step ratio is 0.0525 or less (the lower left side of the curved line F1 of FIG. 11), as described in shape example 6. Furthermore, the residual surface porosity Rh can be brought to 1% or less when the product of the adjacent step ratio and the maximum step ratio is 0.04 or less (the lower left side of the curved line F2 of FIG. 11).

### 1.5: Results of the Present Embodiment

As described above, the shape of a sleeve 1 made of a sintered material having internal pores is specified, whereby the density of each part of the sleeve is made uniform, all of the sintered material can be machined with high density, low-pressure portions are eliminated, the density overall is increased, and the residual surface porosity can be eliminated. As a result, the pressure generated by the hydrodynamic grooves is not reduced/diffused on the surface of the sleeve, and the risk of the lubricating fluid flowing from the residual surface pores is reduced even after long-term use.

The machining precision can be enhanced because there are no portions in which the volume density is excessively high.

As a result, a high-performance hydrodynamic bearing device can be obtained because the pressure is not reduced/diffused even when a sleeve made of a sintered material is used as in the hydrodynamic bearing device. Wear on the bearing can be reliably reduced because the precision of the bearing portion is high and the bearing unit does not become incapable of floating.

### <<Effect of Preventing Pressure Reduction/Diffusion>>

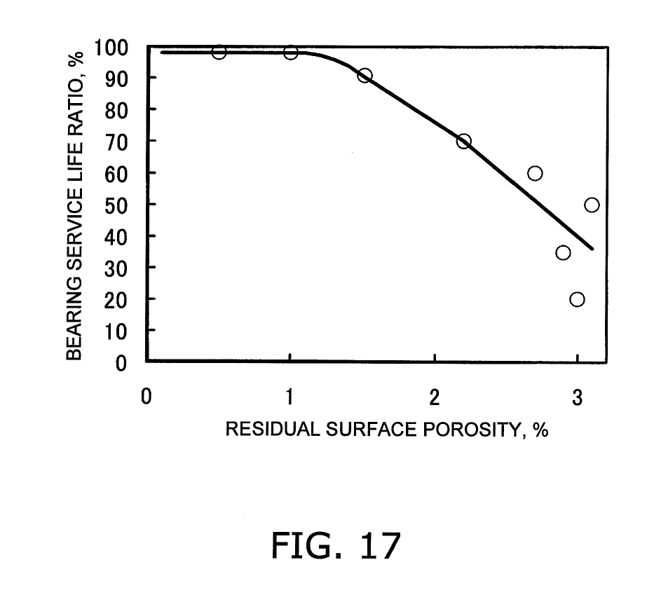

FIG. 17 shows the relationship between the bearing service life and the open porosity in the internal peripheral surface of the bearing hole of the sleeve, and shows an example of the results of experiments carried out by the present inventor.

The evaluation of the bearing service life was determined using the service life at the point at which the motor current increased to a predetermined amount or greater in a continuous rotation test of the hydrodynamic bearing device under high temperature (70° C.)

According to the results of the experiment, the pressure does not sufficiently increase in a hydrodynamic bearing device in which a sleeve having a residual surface pore area ratio in excess of 2% is used. Also, the shaft and sleeve slide during rotation, wear particles are generated on the bearing surface, and service life is dramatically reduced.

On the other hand, through-pores Hp are not present and leakage of the lubricating fluid can be eliminated when the residual surface porosity is 1.5% or less or 1% or less. The surface pores Hs are brought to 1.5% or less or 1% or less of the surface area of the bearing portion, and the aperture surface area and depth of the surface pores is sufficiently low. Therefore, high-pressure generation is obtained without a reduction in the pressure generated by the hydrodynamic grooves of the hydrodynamic bearing device, and the results of the service life test of the hydrodynamic bearing device also indicated that high reliability is obtained.

### 2 Modified Examples of the Sleeve Shape

The present invention is not limited to the embodiments described above. For example, the same effects as the embodiments described above can be obtained by the following sleeve shapes.

### 2.1: MODIFIED EXAMPLE A

In the embodiments described above, cross-sectional shapes of the sleeve 1 have a rectangular shape, as shown in FIG. 8A, and a case is described in which the concavity and convexity having mutually similar shapes are provided above and below the sleeve, but the present invention is not limited this configuration.

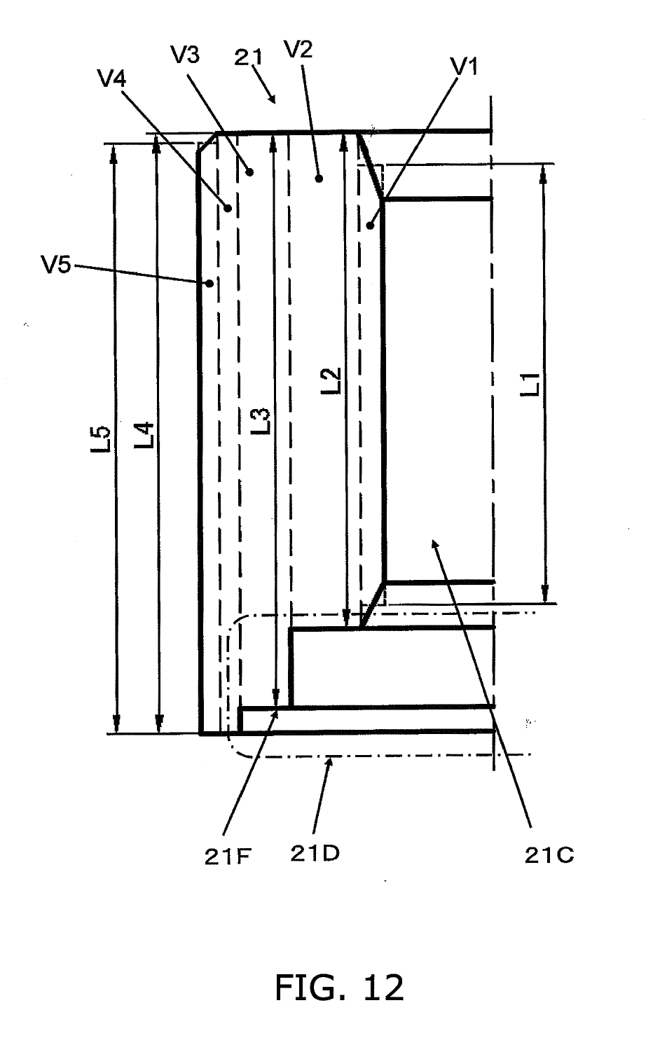

FIG. 12 shows a cross section of half a sleeve 21 of a modified example. A concavity 21D is formed at one end of the sleeve 21, but a convexity having a similar shape is not particularly provided at the other end. In this manner, the axial lengths of the step regions can satisfy any of the conditions of shape examples 2 to 6 even when only the concavity 21D is provided.

In FIG. 12, a tapered portion is formed at the end portions or the like of the bearing hole 21C. In this case, the step regions in the tapered portion can be divided so as to be trapezoidal in shape, as shown by the areas divided by the broken lines in the drawing. The axial length can be an average value in the case that the step regions are trapezoidal. Specifically, a rectangle (indicated by a broken line) in which the cross-sectional surface area is the same in the step region V1 of the innermost portion is hypothesized, and the height L1 of the rectangle can be used as the axial length. The same applies to the case of the step region V5 of the outermost portion.

### 2.2: MODIFIED EXAMPLE B

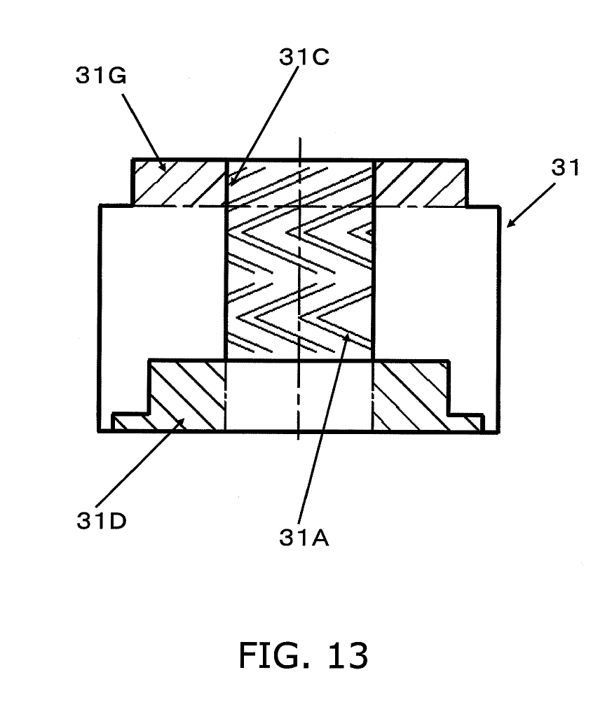

In the modified example shown in FIG. 13, a two-step concavity 31D is formed at one end of the sleeve 31, and a convexity 31G having only a single step is provided at the other end. The concavity 31D and the convexity 31G do not have the same shape in the manner of the modified example described above, but the volume is substantially the same as shown by the shaded portions in the drawing.

In this manner, a concavity 31D for constituting the bearing is provided at one end of the sleeve 31 and the convexity 31G having substantially the same volume is provided at the other end, whereby the axial length Li in any of the step regions Vi of the sleeve 31 can be brought close to substantially the same value regardless of the location. As a result, it is possible to reduce the occurrence of portions in the sleeve 1 in which the volume density is extremely low. More preferred results are obtained because the volume difference is reduced when Pv of the relational expression (1) is set to 1.3.

### 2.3: MODIFIED EXAMPLE C

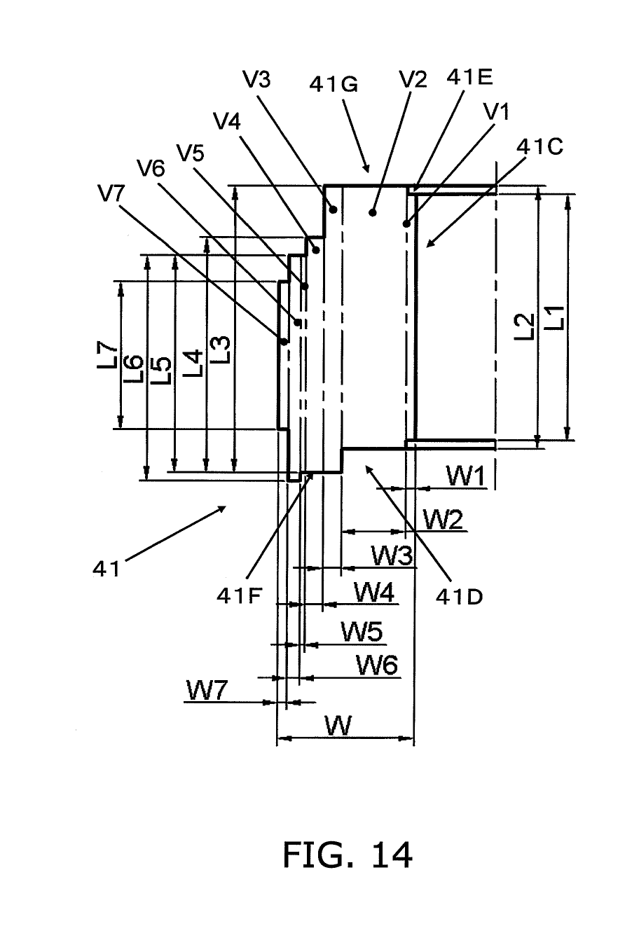

In the modified example shown in FIG. 14, a step region V7 in which the axial length is dramatically less than the other portions is formed in the outermost periphery of the sleeve 41. The drawing shows the cross section of half the sleeve 41.

In FIG. 14, the sleeve 41 has a lower-side concavity 41D for accommodating the flange 3 described above, and a flat surface 41F for securing the thrust plate 4. The lower-side concavity 41D is designed to be sufficiently shallow. An annular lubricating fluid reservoir 41E is formed at the internal periphery of the convexity 41G in the upper portion. The inside diameter of the lubricating fluid reservoir 41E is slightly greater than the inside diameter of the bearing hole, but the radial step W1 is sufficiently small at 10% or less of the total radial width W of the sleeve 41. A tapered shape that increases in diameter from the bearing hole 41C toward the aperture portion may be formed. The steps are 30% or less than the entire length of the sleeve.

The difference between the axial length L7 of the step region V7 and the axial length L6 of the adjacent step region V6 is set so that the ratio (L7−L6)/L6 in relation to L6 is 50% or less. However, the radial width W7 of the step region V7 is 10% or less of the total radial width W. Accordingly, the moldability of the step region V7 is essentially unaffected even when the axial length is considerably different from the adjacent step region V6. The radial width W7 is brought to 5% or less of the total radial width W, whereby the effect on the proccessability is eliminated, the volume density following sintering is made substantially uniform, and the residual surface porosity Rh can be brought to 1% or less.

### 2.4: MODIFIED EXAMPLE D

In the embodiments and modified examples described above, the hydrodynamic bearing device 15 is a shaft rotary-type and an “untied” type, in which one end is close and the other end is open, and the hydrodynamic bearing device is described as having a radial bearing and a thrust bearing. However, the present invention is not limited to the above, and no limit is imposed on the combinations thereof.

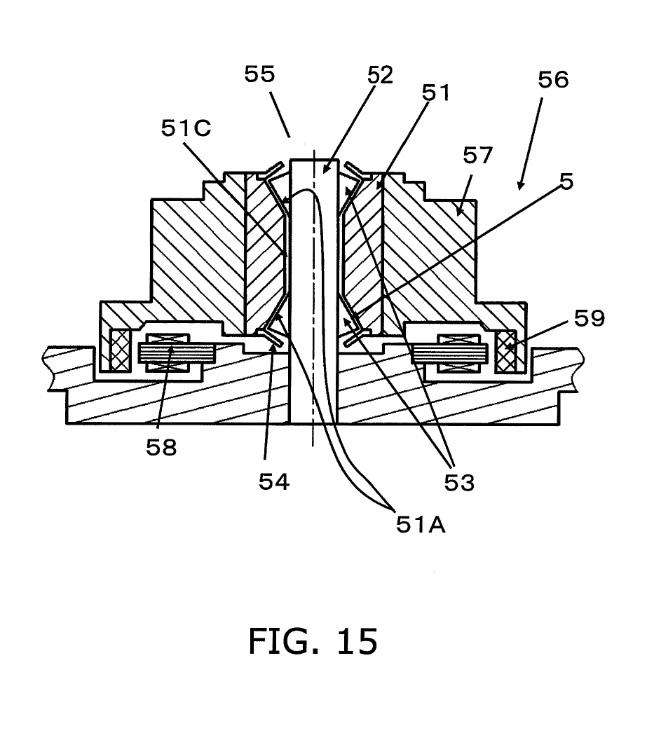

For example, a sleeve 51 shown in FIG. 15 has a conical bearing surface 51A at the two ends. The sleeve 51 is held so as to rotate together with a rotor hub 57 in a non-contacting manner about the periphery of a fixed shaft 52 via a very small gap.

A conical bearing ring 53 is fixed to the fixed shaft 52 so as to face the conical bearing surface 51A. Hydrodynamic grooves (not shown) are provided to the external peripheral surface of the conical bearing ring 53 or to the internal peripheral surface of the conical bearing surface 51A, and produce hydrodynamic force with the aid of the lubricating fluid 5. In this case as well, it is also possible to consider a sleeve shape that is divided into a plurality of steps in the same manner as modified example A. In other words, the shape can be determined so that the step portions satisfy any of the relational expressions.

### 2.5: MODIFIED EXAMPLE E

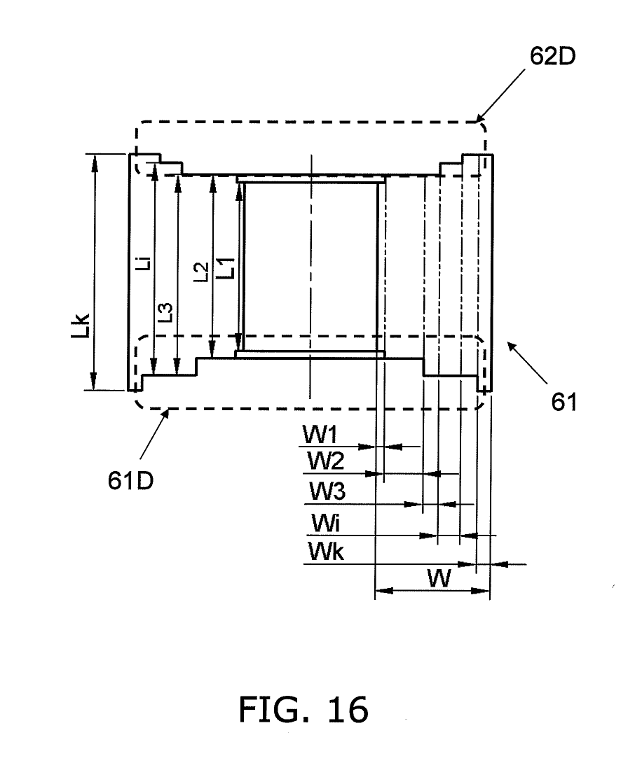

In the modified example shown in FIG. 16, the sleeve 61 has concavities 61D, 62D formed at the two ends thereof. The axial lengths L1, L2, . . . of the step regions can thus satisfy any of the conditions of shape examples 2 to 6 even when the concavities 61D, 62D are formed at the two ends.

The present invention is useful as a hydrodynamic bearing device that uses a high performance, low-cast sleeve, and particularly as a bearing device of a spindle motor for an information device.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A hydrodynamic bearing device comprising:
a sleeve composed of a sintered material and having a compression-absorbing space inside the sleeve, the sleeve having a bearing hole in a center of the sleeve;
a shaft rotatably inserted into the bearing hole;
a bearing portion formed between the bearing hole and the shaft;
a hydrodynamic groove formed on at least one of an internal peripheral surface of the bearing hole and an external peripheral surface of the shaft;
a concavity having one or more steps and formed on one end of the sleeve in an axial direction of the sleeve;
a convexity formed on the other end of the sleeve in the axial direction, the convexity having a shape similar to the concavity; and
a lubricating fluid filled in a gap of the bearing portion.

2. The hydrodynamic bearing device according to claim 1, wherein the concavity and the convexity have substantially the same volume.

3. A hydrodynamic bearing device comprising:
a sleeve composed of a sintered material and having a compression-absorbing space inside the sleeve, the sleeve having a bearing hole in a center of the sleeve;
a shaft rotatably inserted into the bearing hole;
a bearing portion formed between the bearing hole and the shaft;
a hydrodynamic groove formed on at least one of an internal peripheral surface of the bearing hole and an external peripheral surface of the shaft; and
a lubricating fluid filled in a gap of the bearing portion, wherein
the sleeve
has a plurality of step regions arranged in a radial direction of the sleeve, and
satisfies the expression (Lmax−Lmin)/Lmax≦P1, where P1 is a predetermined maximum step ratio, and, with reference to the plurality of step regions, Lmax and Lmin are maximum and minimum values, respectively, of the axial lengths of the step regions which have widths in the radial direction equal to or greater than a predetermined radial width Wr.

4. The hydrodynamic bearing device according to claim 3, wherein
the predetermined radial width Wr is the larger of 0.2 mm and 10% with respect to a total radial direction width W of the sleeve that is from an innermost periphery to an outermost periphery of the sleeve; and
the predetermined maximum step ratio P1 is 25%.

5. The hydrodynamic bearing device according to claim 3, wherein
the sleeve further satisfies the expression |Li−Lj|/max (Li, Lj)≦P2, where P2 is a predetermined adjacent step ratio, and, with reference to the plurality of step regions, Li and Lj are the respective axial lengths of two adjacent step regions among the step regions which have widths in the radial direction equal to or greater than the predetermined radial width Wr.

6. The hydrodynamic bearing device according to claim 5, wherein
the predetermined radial width Wr is the larger of 0.2 mm and 10% with respect to a total radial direction width W of the sleeve that is from an innermost periphery to an outermost periphery of the sleeve;
the predetermined maximum step ratio P1 is 35%; and
the predetermined adjacent step ratio P2 is 15%.

7. A hydrodynamic bearing device comprising:
a sleeve composed of a sintered material and having a compression-absorbing space inside the sleeve, the sleeve having a bearing hole in a center of the sleeve;
a shaft rotatably inserted into the bearing hole;
a bearing portion formed between the bearing hole and the shaft;
a hydrodynamic groove formed on at least one of an internal peripheral surface of the bearing hole and an external peripheral surface of the shaft; and
a lubricating fluid filled in a gap of the bearing portion, wherein
the sleeve
has a plurality of step regions arranged in a radial direction of the sleeve, and
satisfies the expression |Li−Lj|/max (Li, Lj)≦P2, where P2 is a predetermined adjacent step ratio, and, with reference to the plurality of step regions, Li is the axial length of the step region which has a width in the radial direction less than a predetermined radial width Wr, and Lj is the axial length of the step region adjacent in the radial direction to the step region having the axial length Li.

8. The hydrodynamic bearing device according to claim 7, wherein
the predetermined radial width Wr is the larger of 0.2 mm and 10% with respect to a total radial direction width W of the sleeve that is from an innermost periphery to an outermost periphery of the sleeve; and
the predetermined adjacent step ratio P2 is 50%.

9. A hydrodynamic bearing device comprising:
a sleeve composed of a sintered material and having a compression-absorbing space inside the sleeve, the sleeve having a bearing hole in a center of the sleeve;
a shaft rotatably inserted into the bearing hole;
a bearing portion formed between the bearing hole and the shaft;
a hydrodynamic groove formed on at least one of an internal peripheral surface of the bearing hole and an external peripheral surface of the shaft; and
a lubricating fluid filled in a gap of the bearing portion, wherein
the sleeve
has a plurality of step regions arranged in a radial direction of the sleeve, and
satisfies the expression |Li−Lj|/max (Li, Lj)≦P2, where P2 is a predetermined adjacent step ratio, and, with reference to the plurality of step regions, Li and Lj are the respective axial lengths of two adjacent step regions among the step regions which have widths in the radial direction equal to or greater than a predetermined radial width Wr.

10. The hydrodynamic bearing device according to claim 9, wherein
the predetermined radial width Wr is the larger of 0.2 mm and 10% with respect to a total radial direction width W of the sleeve that is from an innermost periphery to an outermost periphery of the sleeve; and
the predetermined adjacent step ratio P2 is 10%.

11. A hydrodynamic bearing device comprising:
a sleeve composed of a sintered material and having a compression-absorbing space inside the sleeve, the sleeve having a bearing hole in a center of the sleeve;
a shaft rotatably inserted into the bearing hole;
a bearing portion formed between the bearing hole and the shaft;
a hydrodynamic groove formed on at least one of an internal peripheral surface of the bearing hole and an external peripheral surface of the shaft; and
a lubricating fluid filled in a gap of the bearing portion, wherein
the sleeve
has a plurality of step regions arranged in a radial direction of the sleeve; and
satisfies the expression |Li−Lj|/max (Li, Lj)*(Lmax−Lmin)/Lmax≦P3, where
P3 is a predetermined step parameter, and
with reference to the plurality of step regions, Li and Lj are the respective axial lengths of two adjacent step regions among the step regions which have widths in the radial direction equal to or greater than the predetermined radial width Wr, and
Lmax and Lmin are maximum and minimum values, respectively, of the axial lengths of the step regions which have widths in the radial direction equal to or greater than the predetermined radial width Wr.

12. The hydrodynamic bearing device according to claim 11, wherein
the predetermined radial width Wr is the larger of 0.2 mm and 10% with respect to a total radial direction width W of the sleeve that is from an innermost periphery to an outermost periphery of the sleeve; and
the predetermined step parameter P3 is 0.0525.

13. A spindle motor comprising the hydrodynamic bearing device according to claim 1.

14. A spindle motor comprising the hydrodynamic bearing device according to claim 3.

15. A spindle motor comprising the hydrodynamic bearing device according to claim 7.

16. A spindle motor comprising the hydrodynamic bearing device according to claim 9.

17. A spindle motor comprising the hydrodynamic bearing device according to claim 11.

18. An information device comprising the spindle motor according to claim 13.

19. An information device comprising the spindle motor according to claim 14.

20. An information device comprising the spindle motor according to claim 15.

21. An information device comprising the spindle motor according to claim 16.

22. An information device comprising the spindle motor according to claim 17.
